(19) United States
(12) Patent Application Publication
(10) Pub. No.: US 2006/0208107 A1
(43) Pub. Date: Sep. 21, 2006

(54) Fuel injector with direct control of the injection valve member and variable boosting

(76) Inventor: Rudolf Heinz, Renningen (DE)

Correspondence Address: RONALD E. GREIGG;GREIGG & GREIGG P.L.L.C., 1423 POWHATAN STREET, UNIT ONE, ALEXANDRIA, VA, 22314, US

(21) Appl. No.: 11/377,558

(22) Filed: Mar. 17, 2006

(30) Foreign Application Priority Data
Mar. 21, 2005 (DE) 10 2005 012 929.3

(51) Int. Cl. F02M 63/00

(52) U.S. Cl. 239/533.2

(57) ABSTRACT

A fuel injector for injecting fuel into an internal combustion engine has an at least two-stage pressure boosting or a variable pressure boosting and an actuator able to actuate an injection valve member. A prestroke element travels a prestroke distance hᵥ during the opening movement of the injection valve member until it reaches a changeover point of the pressure boosting. The injection valve member or a second piston is associated with a prestressing spring element, which can be a disk spring, a tubular spring, a helical spring, or a spring element integrated into the second piston. During the passage through the prestroke distance hᵥ, the prestressing spring element continuously builds up the force required to switch the pressure boosting from a first opening pressure p_{o,1} to a second opening pressure P_{o,2}.

### CROSS-REFERENCE TO RELATED APPLICATIONS

This application is based on German Patent Application 10 2005 012 929.3, filed on Mar. 21, 2005, upon which priority is claimed.

### BACKGROUND OF THE INVENTION

1. Field of the Invention

The invention relates to a fuel injector with direct control of the injection valve member and variable boosting.

2. Description of the Prior Art

EP 1 174 615 A2 relates to a fuel injector having a valve member that cooperates with a valve seat, thus controlling the fuel output of the injector. An actuator device and a hydraulic booster are provided, which serve to transmit the movement of the actuator device to the valve member. The pressure boosting device includes a piston and a control chamber; the actuator device cooperates with the piston element and exerts a retracting force on the piston element. The pressure boosting device is designed so that when an initial retracting force acts on the piston element, the piston element pulls the valve member out of its seat. The movement of the valve member is decoupled from the piston element so that an initial movement of the valve member out of its seat and a continued movement of the valve member are transmitted from the actuator device to the valve member via the fluid inside the control chamber; the pressure booster provides a variable boosting of the movement transmitted from the actuator device to the valve member.

DE 10 2004 028 522.5 relates to a fuel injector with variable actuator boosting. A fuel injector includes a piezoelectric actuator that actuates an injection valve member. A spring element acts on the injection valve member in the closing direction. The fuel injector also includes a hydraulic coupling chamber that hydraulically connects a booster piston and the injection valve member to each other. A sleeve-shaped body is supported on the injection valve member and cooperates with an edge that constitutes an intermediate stroke stop for the injection valve member.

The fuel injector known from EP 1 174 615 A2 has a design that is not favorable from a production engineering standpoint because of its nested pistons. The embodiment according to DE 10 2004 028 522.5 has the inherent disadvantage that in the two-stage hydraulic boosting of the stroke of a piezoelectric actuator implemented therein, a force jump occurs at the changeover between the boosting stages. This means that the actuator being used must generate the force jump by means of an additional stroke, but during this additional stroke, the injection valve member, which is preferably embodied in the form of a nozzle needle, does not move. This in turn means that during this phase, it is not possible for there to be any stroke control of the injection valve member, which is preferably embodied in the form of a nozzle needle. This lack of controllability is extremely undesirable, however.

### OBJECT AND SUMMARY OF THE INVENTION

The object of the present invention is to provide a fuel injector that avoids the above-mentioned technical disadvantage of a stationary phase of the injection valve member during the injection process.

The present invention attains this object by means of a fuel injector with a two-stage hydraulic boosting of the actuator stroke, which generates the force for the required force jump during the action of the first boosting phase and even during the changeover phase, without the injection valve coming to a standstill and in particular, without it experiencing a stationary phase during the changeover from the first boosting stage into the second boosting stage. This advantageously makes it possible to produce a stroke of the injection valve member, which preferably can be embodied in the form of a nozzle needle and which, in the first boosting phase of the two-stage hydraulic boosting, can be controlled over a large voltage range of the actuator. In the context of a preinjection phase, this permits significantly greater precision in the setting of a preinjection quantity to be injected into the combustion chamber of an engine.

Between a prestroke sleeve and a piston element, a spring element is provided, which is embodied as rigid so that the stroke distance hᵥ between the prestroke sleeve and the piston element is sufficient to generate the switching force, i.e. the force required for the force jump. This avoids the force jump that would have otherwise occurred after the piston element came into contact with a prestroke sleeve and instead, the force is gradually built up continuously as the passage through the stroke distance hᵥ occurs during the first boosting phase. With the use of a correspondingly dimensioned spring element, the entire stroke distance hᵥ between the piston element and to the prestroke sleeve can be used to control the injection valve member. The time at which the changeover occurs is pressure-dependent. The spring element is designed so that at the maximum system pressure (common rail pressure), the force required for the force jump is generated after the full stroke distance hᵥ has been traveled. At lower pressures, the changeover point occurs earlier.

There are a wide variety of possible embodiment variants for the spring used. All the embodiment variants share the common trait of having a spring that is as compact and small as possible in order to have the smallest possible hydraulic volume in the control chamber. The spring used for prestressing can be embodied as a disk spring, a tube spring, or a helical spring. In addition to being embodied as a separate component, the spring can also be integrated into the piston element. This embodiment variant is very advantageous since it is unhampered by strict tolerance requirements.

### BRIEF DESCRIPTION OF THE DRAWINGS

The invention will be better understood and further objects and advantages thereof will become more apparent from the ensuing detailed description of preferred embodiments taken in conjunction with the drawings, in which:

FIG. 1 shows a fuel injector with direct control of the injection valve member by means of a booster piston coupled to a prestroke sleeve,

FIG. 2 shows a comparison of the characteristic curves relating to the switching energy, the opening pressures, and the force/stroke characteristics of fuel injectors, with and without a variable boosting mechanism,

FIG. 3 shows a prestressing spring embodied in the form of a disk spring,

FIG. 3.1 shows a developed section through the prestroke sleeve,

FIG. 4 shows a second spring element likewise embodied in the form of a disk spring,

FIG. 5 shows an embodiment variant of the spring element in the form of a tube spring,

FIG. 5.1 shows a portion of a development view of the spring element shown in FIG. 5,

FIG. 6 shows an embodiment variant of the spring element in the form of a helical spring,

FIG. 7 shows a spring integrated into the piston element,

FIG. 8 shows a fuel injector having an injection valve member that can be actuated directly by means of a piezoelectric actuator, equipped with a variable boosting mechanism,

FIG. 9 shows a first embodiment variant of a spring element for use in the fuel injector in FIG. 8,

FIG. 9.1 shows a developed section through a piston guide in order to illustrate the radial grooves,

FIG. 10 shows another embodiment variant of a spring element for use in the fuel injector in FIG. 8, and

FIG. 10.1 shows an alternative embodiment variant of the spring element.

### DESCRIPTION OF THE PREFERRED EMBODIMENTS

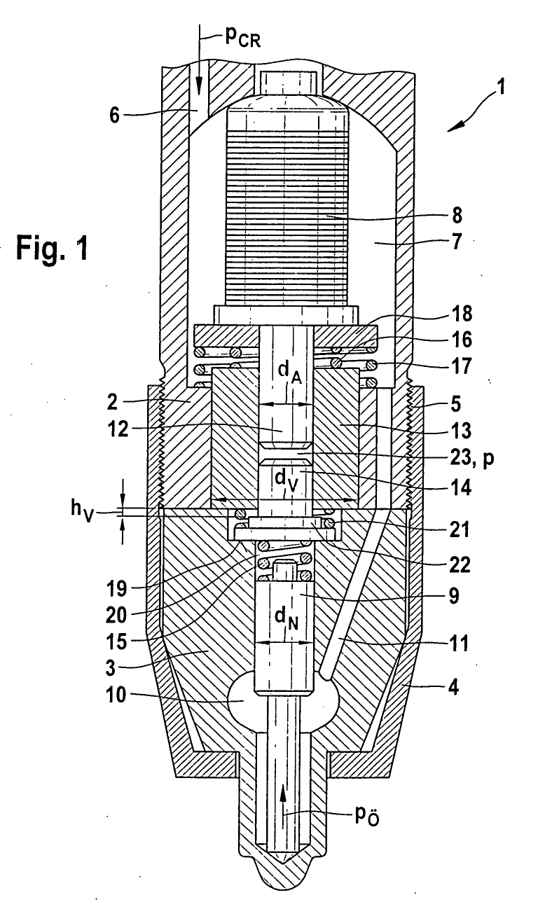

FIG. 1 is a longitudinal section through a fuel injector according to the invention, with direct control of the injection valve member and a variable boosting of the stroke travel of a piezoelectric actuator.

A fuel injector 1 includes an injector body 2 that is also referred to as a holding body. A retaining nut 4 connects the injector body 2 of the fuel injector 1 to a threaded region 5 on a nozzle body 3. The injector body 2 has a high-pressure connection 6 via which a cavity contained in the injector body 2 is subjected to system pressure p_{CR}, i.e. the fuel pressure level prevailing in a high-pressure reservoir (common rail). From the chamber 7 of the injector body 2, a nozzle chamber inlet 11 leads to a nozzle chamber 10, which is contained in the nozzle body 3 and encompasses an injection valve member 9. In the region of the nozzle chamber 10, which is likewise subjected to system pressure, a pressure shoulder is provided on the injection valve member 9. The system pressure prevailing in the nozzle chamber 10 acts in the opening direction on the injection valve member 9.

The chamber 7 of the injector body 2 contains a piezoelectric actuator 8. The piezoelectric actuator 8 is depicted only in schematic form in FIG. 1 and includes a multitude of stacked piezoelectric crystals that cause the piezoelectric actuator 8 to change in length when it is supplied with current. This causes the piezoelectric actuator 8 to expand in the vertical direction inside the chamber 7 of the injector body 2, thus generating the forces required to actuate injection valve member 9. But if the supply of current to the piezoelectric actuator is partially or completely switched off, then the individual piezoelectric crystals stacked one on top of another in the vertical direction revert to their original length in the vertical direction so that the piezoelectric actuator 8 as a whole reverts to its original length in the currentless state.

It is clear from FIG. 1 that a prestroke sleeve 13 encompasses both a first piston 12 and a second piston 14. The two opposed end surfaces of the first piston 12 and second piston 14, along with the prestroke sleeve 13 encompassing the two pistons 12 and 14, delimit a hydraulic coupling chamber 23. The outer diameter of the prestroke sleeve 13 is labeled dᵥ.

A disk-shaped stop 18 is situated on the first piston 12 and rests against the underside of the piezoelectric actuator 8. The disk-shaped stop 18 acts on both an inner spring element 16 and an outer spring element 17, both of which can be embodied in the form of helical springs, for example. The inner spring element 16 rests against an end surface of the prestroke sleeve 13 while the outer spring element 17 rests against a surface of the injector body 2 that in turn encompasses the prestroke sleeve 13. The end surfaces of both the injector body 2 and prestroke sleeve 13 oriented away from the piezoelectric actuator 8 rest against an upper flat surface of the nozzle body 3 along a parting line. The diameter of the first piston 12 is labeled d_{A}.

Below the prestroke sleeve 13 in FIG. 1, the nozzle body 3 of the fuel injector 1 contains a cavity. The second piston 14 is accommodated in this cavity and its tapered end protrudes into the prestroke sleeve 13 and in the coupling chamber 23, is situated opposite the end surface of the first piston 12. A prestressing spring 21 is mounted on the second piston 14 and rests against a collar 22 of the second piston 14 at one end, while resting against a lower end surface of the prestroke sleeve 13 at the other. A bore that is not shown in detail hydraulically connects the cavity to a control chamber 20 that acts on a piston end surface 19 of the second piston 14. In FIG. 1, the piston end surface 19 rests against a flat surface of the nozzle body 3 above the injection valve member 9 contained therein.

The control chamber 20 that contains a control chamber spring element 15 is situated beneath the second piston 14 on which the prestressing spring 21 is mounted. The control chamber spring element 15 rests against the piston end surface 19 of the second piston 14 at one end and rests against an end surface of the needle-shaped injection valve member 9 at the other. The injection valve member 9 has a diameter d_{N} above the nozzle chamber 10.

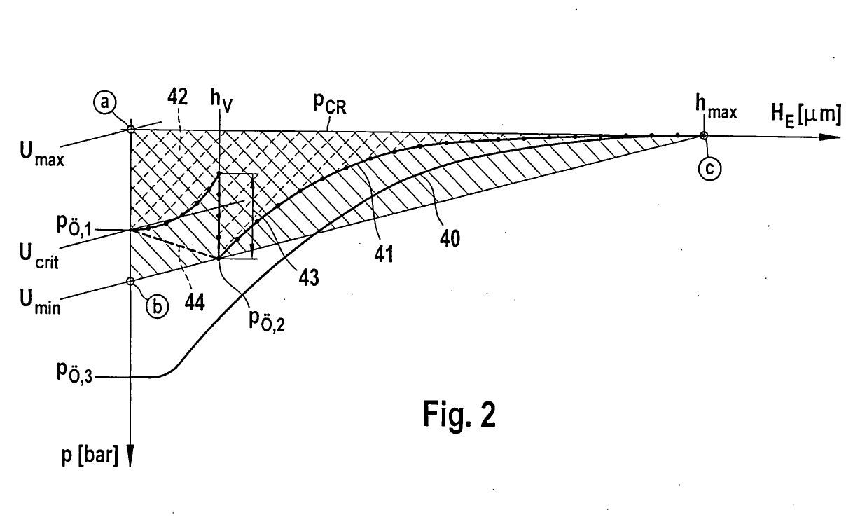

FIG. 2 shows a comparison of the characteristic curves relating to the switching energy, the opening pressures, and the force/stroke characteristics of fuel injectors, with and without a variable boosting mechanism. In FIG. 2, the pressure in the coupling chamber 23 is plotted over the stroke h_{E} of the injection valve member 9. The opening force curve 40 for a piezoelectric actuator, which is used to actuate the fuel injector without stepped boosting, demonstrates that its opening pressure P_{o,3} lies significantly below the opening pressure p_{o,1} of a fuel injector operating with a piezoelectric actuator 8 equipped with stepped boosting. In accordance with the opening force curve 40, a piezoelectric actuator 8 operating without stepped boosting requires a switching energy indicated by the crosshatched region defined by the triangle abc in FIG. 2.

Consequently, the second opening pressure p_{o,2} of the injection valve member 9 of a fuel injector 1 with a piezoelectric actuator 8 and a stepped boosting is significantly lower. The injection valve member 9 thus also requires less of an actuation force so that a piezoelectric actuator 8 of this kind has a smaller volume, i.e. is more compact and therefore takes up less space.

According to the opening force curve 41 for a fuel injector with a piezoelectric actuator 8 and stepped boosting, the pressure p in the coupling chamber 23 decreases once the prestroke hᵥ is reached and, after a force jump labeled with the reference numeral 43 in FIG. 2, increases sharply again, the sharpness of the increase falling away degressively as it approaches the system pressure p_{CR}. When the maximum opening stroke hₘₐₓ of the injection valve member 9 is reached, the pressure p in the coupling chamber 23 is identical to the system pressure p_{CR}. The switching energy of a fuel injector whose injection valve member 9 is directly triggered by a piezoelectric actuator 8 is significantly lower, see reference numeral 42 and the dashed region in FIG. 2, so that a corresponding piezoelectric actuator 8 can be smaller without impairing the function of a fuel injector 1 with a directly triggered injection valve member 9. Both the presence of the prestressing spring 21 according to the invention, which can be embodied in several embodiment variants, and its rigidity make it possible to avoid the force jump 43 indicated in FIG. 2 and to replace it with a continuous buildup of force according to the line 44. By contrast with the force jump 43, the very rigid prestressing spring 21 proposed according to the invention can permit the changeover force to be built up gradually during the passage through the stroke distance hᵥ in the first boosting stage. The transition to the second boosting stage then no longer occurs with a force jump 43, as shown in FIG. 2, but instead occurs continuously. When there is a force jump 43 of the kind shown in FIG. 2, in order to control the injection valve member 9, the voltage of the actuator 8 can be controlled between U_{crit} and Uₘᵢₙ since the force jump 43 usually occurs in this range. But if a prestressing spring 21 according to the invention is used, then the force continuously rises in a gradual fashion from 0 until the stroke distance hᵥ is reached. As is clear from FIG. 2, the injection valve member 9 is thus continuously triggered from U_{crit} to Uₘᵢₙ, which makes it possible to produce a preinjection over a larger voltage range, which significantly improves the precision of the preinjection quantity due to the possibilities for finely graduating the impingement of voltage on the actuator during the first boosting phase.

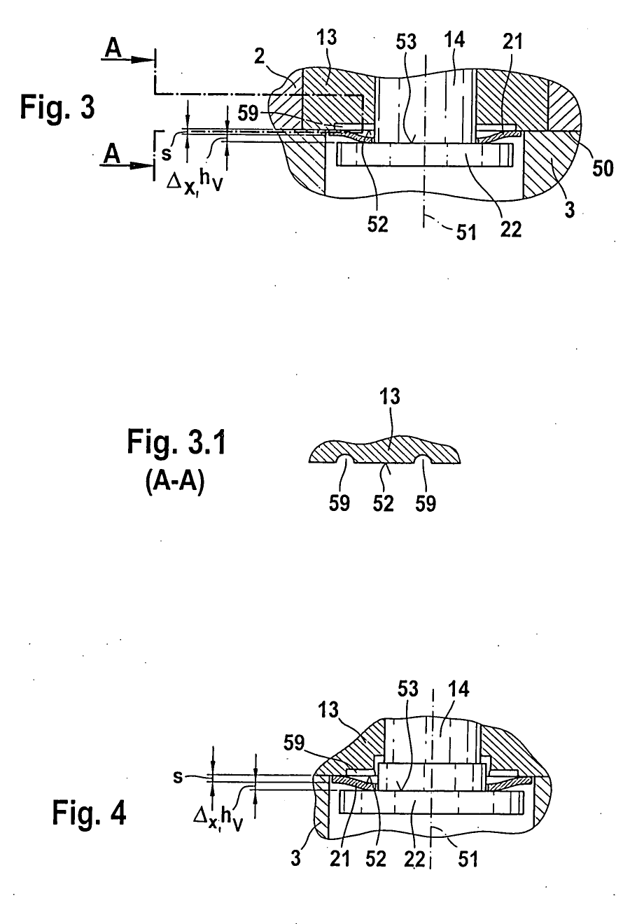

FIG. 3 shows an embodiment of the prestressing spring 21 embodied in the form of a disk spring extending in the axial direction of the second piston 14. A stroke gap labeled Δx corresponds to the prestroke distance hᵥ, and s is the thickness of the prestressing spring 21 embodied in the form of a disk spring.

It is clear from FIG. 3 that the second piston 14 has a collar 22 whose surface 53 supports the prestressing spring 21 embodied in the form of a disk spring. On the other side, the prestressing spring 21 rests against an end surface 52 of the prestroke sleeve 13. The prestroke sleeve 13, in turn, is encompassed by the injector body 2 of the fuel injector 1. The prestressing spring 21 is contained in the stroke gap Δx. FIG. 3.1 shows that radial grooves 59 are provided in the end surface 52 of the prestroke sleeve for pressure compensation or equalization purposes.

FIG. 4 shows another embodiment variant of a spring element embodied in the form of a disk spring. It is clear from this embodiment variant that the spring element 21 embodied in the form of a disk spring is contained between the collar 22, i.e. its support surface 53, and the lower end 52 of the prestroke sleeve 13. The stroke gap Δx corresponds to the prestroke distance hᵥ. According to the embodiment variant shown in FIG. 4, the second piston 14 and the collar 22 constitute two separate components that are distinct from each other. The prestressing spring 21 embodied in the form of a disk spring exerts the prestressing force. The slaving of the piston 14 due to the form-locked engagement occurs after the passage through the stroke gap Δx. Consequently, the functions of generating the prestressing force and bringing the stroke to a standstill are completely separate from each other.

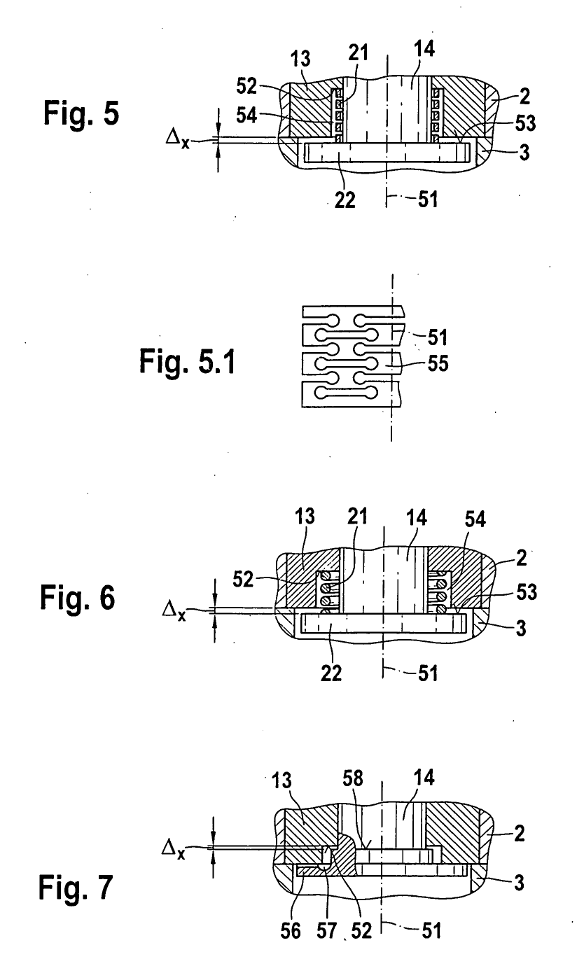

FIG. 5 shows another embodiment variant of the prestressing spring in the form of a tube spring 21 that can be embodied in the form of a tube spring that can be contained in a receptacle 54 in the prestroke sleeve 13. According to the embodiment variant of the prestressing spring 21 in FIG. 5, the spring rests against a top 52 of the receptacle 54 at one end and rests against the support surface 53 of the collar 22 of the second piston 14 at the other end. The stroke gap is labeled Δx and is identical to the prestroke distance hᵥ.

FIG. 5.1 is a developed depiction of the circumference surface 55 of a prestressing spring 21 embodied in the form of a tube spring. The tube spring has a regular or irregular pattern of slots and circular openings that can be situated offset from one another with reference to the symmetry axis 51 of the prestressing spring 21. The design of the slot width and the diameter of the circular end regions can be used to adjust the rigidity of a prestressing spring 21 embodied in the form of a tube spring and can optimally adapt it to the respective intended use.

FIG. 6 shows a prestressing spring embodied in the form of a helical spring. Analogous to the depiction in FIG. 5, in this embodiment variant, the prestroke sleeve 13 contains a receptacle 54 that accommodates the prestressing spring 21. The prestressing spring 21 according to the embodiment variant shown in FIG. 6 rests against a top 52 of the receptacle 54 at one end and against the support surface 53 of the collar 22 of the second piston 14 at the other end. A prestressing spring 21 embodied in the form of a spiral or helical spring is a particularly inexpensive component.

FIG. 7 shows another embodiment variant of a prestressing spring that is embodied on a piston element.

In the embodiment variant shown in FIG. 7, the second piston 14, which is embodied as symmetrical to the symmetry axis 51, has a spring element 56 integrated into it. This spring element can have at least one contact surface 58, which contacts the underside of the prestroke sleeve 13. In order to influence the spring characteristics of the integrated spring element 56, an annular groove is provided that extends in a circular fashion around the integrated spring element 56. The spring element 56 integrated into the second piston 14 is distinguished primarily by the fact that it can be manufactured practically unhampered by any tolerance-related considerations. The stroke gap is labeled Δx and is identical to the stroke distance hᵥ of the prestroke sleeve.

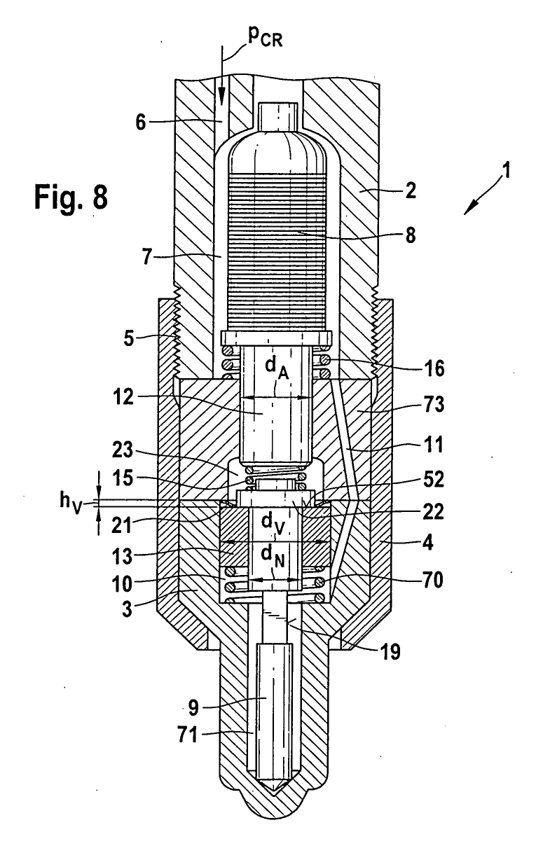

FIG. 8 shows a fuel injector having an injection valve member, which can be actuated directly by means of a piezoelectric actuator, and having a variable boosting mechanism.

It is clear from FIG. 8 that the fuel injector 1 shown, analogous to the fuel injector shown in FIG. 1, has a piezoelectric actuator 8 contained inside a chamber 7. A high-pressure source that is not shown in detail supplies the chamber 7 with fuel at system pressure p_{CR} via the high-pressure connection 6. A securing bush 4 connects the injector body 2 to the nozzle body 3. A piston guide 73 that is likewise encompassed by the securing bush 4 is situated between the injector body 2 and the nozzle body 3. A nozzle chamber inlet 11 passes through both the piston guide 73 and the nozzle body 3 and feeds into the pressure chamber 10. The piezoelectric actuator 8 acts on a first piston 12 that has an outer diameter d_{A}. The first piston 12 protrudes into the coupling chamber 23 that also contains the collar 22, which in this embodiment variant, is also connected to the injection valve member 9. A control chamber spring element 15 is situated between the collar 22 and the end surface of the first piston 12 oriented toward the coupler chamber 23. The prestroke sleeve 13 contacts the underside of the collar 22 and is acted on by a spring element 70, which is in turn supported in the nozzle body 3. From the nozzle chamber 10, an annular gap 71 extends in the direction of the seat of the injection valve member 9. Fuel at system pressure p_{CR} flows through the annular gap 71 toward the injection openings, not shown in FIG. 8, that are located at the combustion chamber end of the nozzle body 3. In the embodiment variant of the fuel injector 1 according to FIG. 8, the prestressing spring 21 is situated between the underside of the piston guide 73 and the end surface of the prestroke sleeve 13 oriented toward the coupling chamber 23.

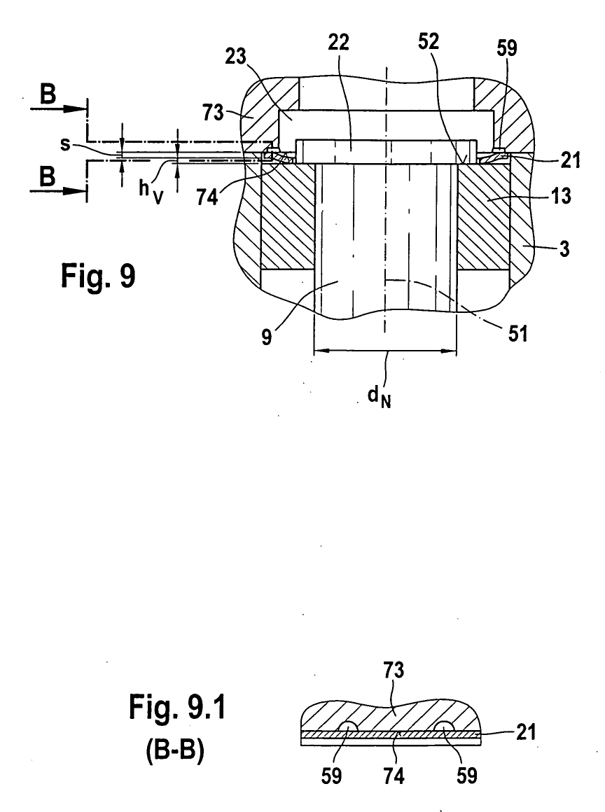

FIG. 9 shows a disk-shaped embodiment variant of the prestressing spring 21 employed in FIG. 8. The prestressing spring 21 is situated next to the collar 22, resting against the end surface 52 of the prestroke sleeve 13 on one side and resting against a support surface 74 on the underside of the piston guide 73 on the other. The injection valve member 9, which is embodied as symmetrical to the symmetry axis 51, has a diameter d_{N}. The prestroke sleeve 13 encompasses the injection valve member 9 and rests against the underside of the collar 22. The prestressing spring 21 is effective along the stroke distance hᵥ and this stroke distance hᵥ corresponds to the stroke gap Δx.

FIG. 9.1 shows a developed section through the piston guide 73, whose support surface 74 is provided with radial grooves 59 for pressure compensation purposes.

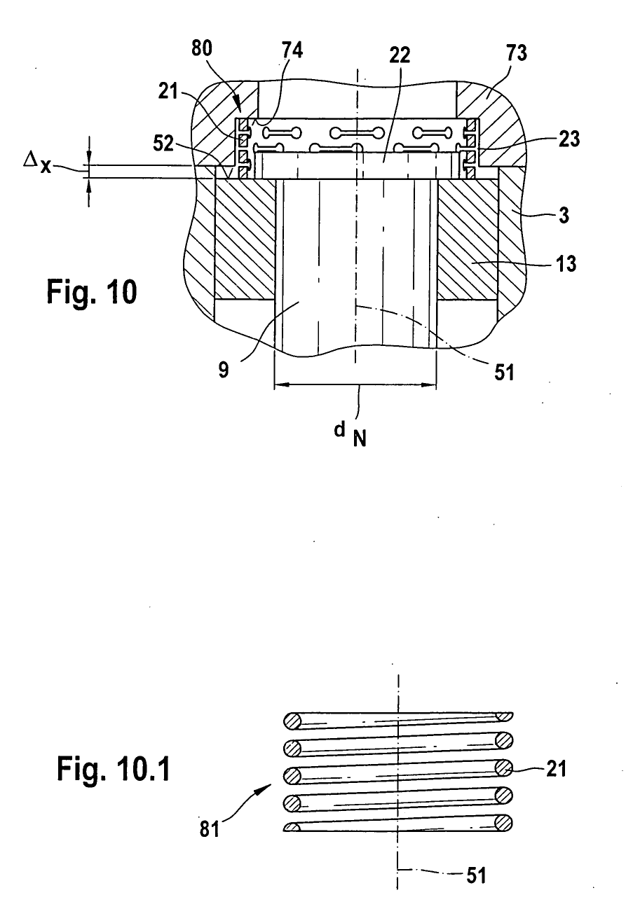

FIGS. 10 and 10.1 show other embodiment variants of prestressing springs that can be used in the embodiment of the fuel injector in FIG. 8.

The prestressing spring 21 can be embodied in the form of a tube spring with a rectangular coil cross section 80 according to the depiction in FIG. 10, a tube spring according to FIG. 5. 1, or a round spring wire cross section according to FIG. 10.1. In both cases, the prestressing spring 21 thus embodied is partially contained in the piston guide 73 and rests against its support surface 74. At the other end, the prestressing spring 21 rests against the end surface 52 of the prestroke sleeve 13. The stroke gap is labeled Δx and as this gap is bridged, a prestressing force is generated.

As described above, the very rigid prestressing spring 21 according to the invention can be used in fuel injectors of the embodiment type in FIG. 1 and in fuel injectors of the embodiment type in FIG. 8. The prestressing spring 21, which can be embodied as a disk spring, a tubular spring, a helical spring, or a spring element integrated into the piston 14, avoids the force jump 73 shown in FIG. 2 and replaces it with a continuously occurring force buildup according to the characteristic curve 44 in FIG. 2. As a result, during the action of the first boosting stage, the force for the previously required force jump 43 can build up gradually without the injection valve member 9 coming to a standstill; instead, the injection valve member 9 remains constantly in motion. The broadened voltage range between U_{crit} and Uₘᵢₙ of the actuator 8 thus makes it possible to adjust the preinjection quantity with significantly greater precision during the first boosting stage than was possible in fuel injectors with pressure boosting, which have a force jump 43 according to the depiction in FIG. 2 at the changeover from the first boosting stage into the second boosting stage.

The foregoing relates to preferred exemplary embodiments of the invention, it being understood that other variants and embodiments thereof are possible within the spirit and scope of the invention, the latter being defined by the appended claims.

I claim:

1. A fuel injector for injecting fuel into the combustion chamber of an internal combustion engine, the injector comprising
an at least two-stage pressure boosting or variable pressure boosting,
an actuator that is able to actuate an injection valve member,
a prestroke element that travels a prestroke distance hᵥ during the opening movement of the injection valve member until it reaches a changeover point of the pressure boosting, and,
a prestressing spring element associated with the injection valve member or a second piston is associated,
the prestressing spring element being operable to continuously build up the force required to switch the pressure boosting from a first opening pressure p_{o,1} to a second opening pressure P_{o,2} during the passage through the prestroke distance hᵥ.

2. The fuel injector according to claim 1, wherein the prestroke element comprises a sleeve that either encompasses the first piston or is contained in a spring-loaded fashion in the head region of the injection valve member.

3. The fuel injector according to claim 1, wherein the prestressing spring element is embodied comprises a disk spring, a tube spring, a helical spring, or a spring element integrated into the first piston.

4. The fuel injector according to claim 1, wherein the prestressing spring element comprises a tube spring or a helical spring, and wherein the coils of the prestressing spring element are embodied as rectangular, polygonal, or circular in cross section.

5. The fuel injector according to claim 1, wherein the prestressing spring element rests against a support surface of a collar of the second piston at one end and rests against an end surface of the prestroke element at the other.

6. The fuel injector according to claim 1, wherein the prestressing spring element rests against an end surface of the prestroke element at one end and rests against a support surface of the piston guide at the other.

7. The fuel injector according to claim 3, wherein the spring element is integrated into the second piston and has a contact surface that rests against an end surface of the prestroke element.

8. The fuel injector according to claim 7, wherein the prestressing spring element comprises a cross sectional restriction.

9. The fuel injector according to claim 2, wherein either an end surface of the prestroke element or the support surface of the piston guide comprises radial grooves for pressure compensation purposes.

10. The fuel injector according to claim 6, wherein either an end surface of the prestroke element or the support surface of the piston guide comprises radial grooves for pressure compensation purposes.

11. The fuel injector according to claim 1, wherein, in order to control a preinjection quantity, the actuator is triggered with a voltage of between U_{crit} and Uₘᵢₙ during the passage through a prestroke distance hᵥ and after the passage through the pressure boosting stage that corresponds to the prestroke distance hᵥ, the injection valve member is steadily moved further beyond the changeover point.
